(19) United States
(12) Patent Application Publication
(10) Pub. No.: US 2020/0369144 A1
(43) Pub. Date: Nov. 26, 2020

(54) FUEL-PICK-UP DEVICE

(71) Applicant: FUEL ACTIVE LIMITED, Caediff South Glamorgan (GB)

(72) Inventor: Paul Graham Bateman, Cardiff South Glamorgan (GB)

(21) Appl. No.: 16/636,245

(22) PCT Filed: Aug. 3, 2018
(86) PCT No.: PCT/GB2018/052234

§ 371 Date: Feb. 3, 2020

(30) Foreign Application Priority Data
Aug. 4, 2017 (GB) 1712587.3

(51) Int. Cl. B60K 15/03; B01D 29/33; B01D 35/00; B01D 35/027

(52) U.S. Cl. CPC B60K 15/03; B01D 29/33; B60K 2015/03236; B01D 35/0276; B60K 2015/03217; B01D 35/005

(57) ABSTRACT

A fuel pick-up device (11) for a fuel tank (10) comprises a float (17) arranged for rising and falling with the level of fuel (F) in the tank (10) and a plurality of elongate flexible tubes (16a, 16b) extending helically from the float (17) to a fuel outlet (15) of the device (11), the float (17) being arranged for generally vertical movement within an apertured sleeve (13). The flexible tubes (16a, 16b) are sufficiently thin to allow the float (17) to freely rise and fall with the level of the fuel (F). However, the combined cross-sectional area of the ducts provided by the plurality of flexible tubes (16a, 16b) is sufficient to allow fuel to be drawn from the tank at a high flow rate sufficient for large engines.

This invention relates to a fuel pick-up device for use in drawing fuel from a tank or other reservoir.

In conventional fuel tanks, the fuel is drawn from a point adjacent the bottom of the tank, so as to enable the pick-up of fuel even when the level of fuel in the tank is low. However, a disadvantage of this arrangement is that any water, sediment or other contaminants which have accumulated at the bottom of the tank can be drawn up with the fuel and fed to the apparatus which is being supplied with fuel. In most cases, fuel is being supplied to an internal combustion engine and any contaminant in the fuel could undesirably stop or damage the engine.

GB2350337 and GB2446011 each disclose a solution to this problem in the form of a float device having a float arranged for rising and falling with the level of fuel in the tank and a flexible tube having its free end coupled to the float, the float being arranged for vertical movement within a tubular filter, which encloses the float and the flexible tube.

In use, the float ensures that the fuel is always picked up from a point adjacent the surface of the fuel in the tank. Accordingly, the risk of drawing up contaminants from the bottom of the tank is alleviated.

Whilst fuel pick-up devices of the kind disclosed in GB2350337 and GB2446011 have found utility in smaller machines, they have failed to find utility in larger machines, such as large earthmoving and mining vehicles and the like, which comprise very large internal combustion engines that are fed with fuel from a large fuel tanks. Such machines are extremely expensive and any interruption to the operation of the machine by contaminated fuel can have a significant impact on the output and profitability of the company operating the machine.

We have now devised an improved fuel pick-up device which is particularly suited for larger machines.

In accordance with the present invention, there is provided a fuel pick-up device comprising a float arranged for rising and falling with the level of fuel in a tank and a plurality of elongate flexible tubes extending from the float to a fuel outlet of the device, the float being arranged for generally vertical movement within a constraint which encloses the float and the elongate flexible tubes.

In larger machines, the volume of fuel drawn from the tank is large and hence a device of the kind disclosed in GB2350337 and GB2446011 would have to have a flexible tube of sufficient diameter to accommodate the increased flow rate. However, a problem of providing a tube of increased diameter is that such tubes are inherently less flexible and thus the float is prevented from freely rising and falling with the level of fuel in the tank. The present invention overcomes this problem by providing a plurality of elongate flexible tubes, which are fluidly connected in parallel between the float and the fuel outlet of the device and which are sufficiently thin to allow the float to freely rise and fall with the level of the fuel. However, the combined cross-sectional area of the ducts provided by the plurality elongate tubes is sufficient to allow fuel to be drawn from the tank at a high flow rate sufficient for large machines.

In a preferred embodiment, there may be just two elongate flexible tubes extending between the float and the outlet.

The elongate flexible tubes ideally extend independently of each other between the float and the outlet.

The plurality of elongate flexible tubes may extend helically between the float and the outlet about a longitudinal axis along which the float rises and falls.

The helical turns of each elongate flexible tube may be circumferentially offset about the axis by an angle of 360°/n, where n is the number of flexible tubes. Hence, a device having two tubes would have the helical turns offset by 180°.

The elongate flexible tubes may comprise open ends at the float, so that fuel can flow directly into the elongate flexible tubes. Alternatively, each elongate flexible tube may connect to a filter provided on the float, for example at a lower end of the float.

The elongate flexible tubes may be recessed into a tubular side wall of the float, so as to allow the elongate flexible tubes to extend towards the bottom of the float.

The elongate flexible tubes may be recessed in respective channels which extend helically of the side wall of the float.

The outlet may comprise a single outlet having a manifold which fluidly connects each elongate flexible tube. Alternatively, each elongate flexible tube may have a respective outlet.

The tubes may be engaged with the upper end of the filter, for example by extending through apertured formations in the float.

An embodiment of the present invention will now be described by way of example only and with reference to the accompanying drawings, in which:

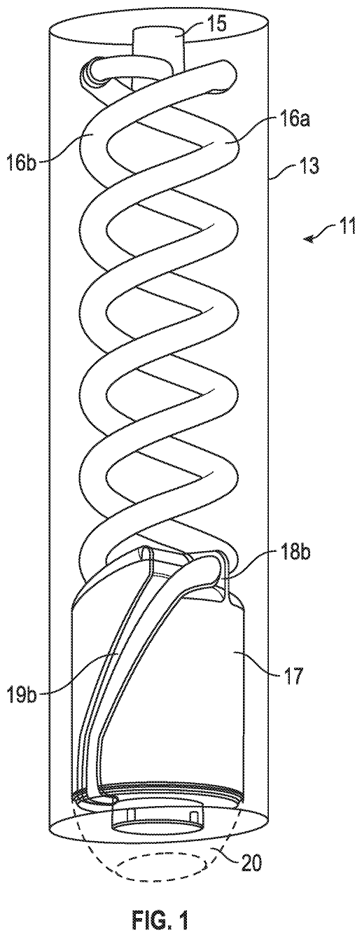

FIG. 1 is a perspective view, from one side and below, of internal components of a fuel pick-up in device accordance with the present invention; and

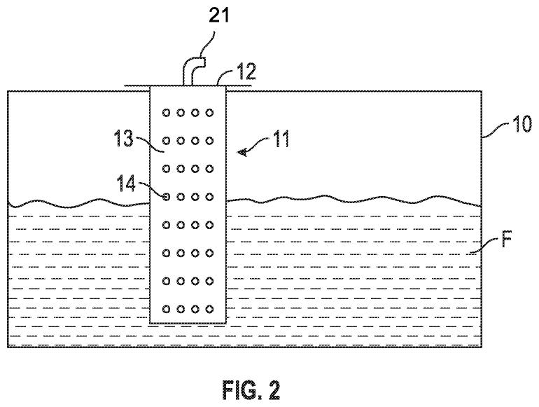

FIG. 2 is a schematic sectional view through a fuel tank to which the fuel pick-up device of FIG. 1 is fitted.

Referring to the drawings, there is shown a fuel tank 10 containing fuel F to which a fuel pick-up device 11 in accordance with the present invention is fitted. The device 11 is fitted to a circular aperture formed in the top wall of the tank 10. The device 11 comprises an elongate circular-section filter 13 in the form of a metal sleeve provided with an array of apertures 14. The sleeve 13 is open at its lower end and closed at its upper end by a flanged end cap 12, which is secured around its periphery to the edges of the aperture in the tank 10. A tubular fuel outlet duct 21 extends from the flanged end cap 12 for connecting to the engine of a machine.

The lower end of the outlet duct 21 is connected to a manifold 15 having two tubular arms, which are respectively connected to a pair of elongate helically-coiled flexible tubes 16a, 16b of plastics material. It is envisaged that the elongate helically-coiled flexible tubes 16a, 16b may be formed by wrapping straight tubes around a mandrel and then applying heat to the tube. The turns of the elongate helically-coiled flexible tubes 16a, 16b are offset from each other by an angle of 180° relative to the longitudinal axis of the sleeve 13.

A hollow tubular float 17 of plastics material is disposed inside the sleeve 13 and is connected to the lower ends of the elongate helically-coiled flexible tubes 16a, 16b. The float 17 has a tubular side wall of a diameter which is slightly less than the internal diameter of the sleeve 13, so that the float 17 can freely rise and fall inside the sleeve 13. The lower ends of the elongate helically-coiled flexible tubes 16a, 16b are attached to the upper ends of the float 17 by extending the tubes through respective apertured formations e.g. 18b on the upper end of the float 17. elongate helically-coiled flexible tubes 16a, 16b then extend helically down towards the lower end of the float in respective recessed channels e.g. 19b formed in the side of the float 17. The lower ends of the elongate helically-coiled flexible tubes 16a, 16b open into a bottom filter chamber 20 having side walls which are provided with apertures.

In use, the float 17 floats on the surface of the fuel F and fuel is drawn into the filter chamber 20 through the apertured side walls thereof and along the elongate helically-coiled flexible tube 16a, 16b. The apertures in the side walls of the filter chamber 20 serve to filter the fuel and prevent sediment and other contaminants from being drawn up the elongate helically-coiled flexible tubes 16a, 16b. The apertures 14 in the sleeve 13 also serve to prevent suspended sediment and other contaminants from entering the device. The fuel then flows out of the elongate helically-coiled flexible tubes 16a, 16b to the outlet 21 via the manifold 15.

The elongate helically-coiled flexible tubes 16a, 16b are sufficiently flexible to allow the float 17 to freely rise and fall inside the sleeve 13 according to the level of fuel F in the tank 10. However, the combined cross-sectional area of the ducts provided by the elongate helically-coiled flexible tubes 16a, 16b is sufficient to allow fuel F to be drawn from the tank 10 at a high flow rate.

1. A fuel pick-up device comprising a float arranged for rising and falling with the level of fuel in a tank and a plurality of elongate flexible tubes extending from the float to a fuel outlet of the device, the float being arranged for generally vertical movement within a constraint which encloses the float and the elongate flexible tubes.

2. A fuel pick-up device as claimed in claim 1, in which solely two of said elongate flexible tube extending between the float and the outlet.

3. A fuel pick-up device as claimed in claim 1, in which the elongate flexible tubes extend independently of each other between the float and the outlet.

4. A fuel pick-up device as claimed in claim 1, in which the plurality of elongate flexible tubes extend helically between the float and the outlet about a longitudinal axis along which the float rises and falls in use.

5. A fuel pick-up device as claimed in claim 4, in which the helical turns of each elongate flexible tube are circumferentially offset about said axis by an angle of 360°/n, where n is the number of flexible tubes.

6. A fuel pick-up device as claimed in claim 1, in which the elongate flexible tubes comprise open ends at the float.

7. A fuel pick-up device as claimed in claim 1, in which each elongate flexible tube is connected to a filter provided on the float.

8. A fuel pick-up device as claimed in claim 1, in which the elongate flexible tubes are recessed into a tubular side wall of the float.

9. A fuel pick-up device as claimed in claim 8, in which the elongate flexible tubes are recessed in respective channels which extend helically of the side wall of the float.

10. A fuel pick-up device as claimed in claim 1, in which the outlet comprises a single outlet having a manifold which fluidly interconnects connects each elongate flexible tube.

11. A fuel pick-up device as claimed in claim 1, in which each elongate flexible tube has a respective outlet.

12. A fuel pick-up device as claimed in claim 1, in which the tubes are engaged with an upper end of the filter.
